(19) United States
(12) Patent Application Publication
(10) Pub. No.: US 2014/0229392 A1
(43) Pub. Date: Aug. 14, 2014

(54) Carbon-Capture Utilization by Municipal Utility Companies for Environment Rehabilitation, Water & Energy Recycling, and Greening of Desert

(71) Applicant: Tarim Resource Recycling Co., Haslemere (GB)

(72) Inventor: Kenneth J. Hsu, Haslemere (GB)

(73) Assignee: Tarim Resource Recycling Co., Haslemere (GB)

(21) Appl. No.: 14/255,202

(22) Filed: Apr. 17, 2014

Related U.S. Application Data
(63) Continuation-in-part of application No. 13/625,963, filed on Sep. 25, 2012, now abandoned.

(51) Int. Cl. G06Q 10/00

(52) U.S. Cl. CPC G06Q 10/30
USPC 705/308

(57) ABSTRACT

A system-engineering is invented to install facilities for water- and energy-recycling, either in or near a city, and/or in a pre-existing or a new city park, includes one by an utility company to collect carbon emissions wherein the carbon dioxide is produced by burning of high-carbon fuels or lime, one by the same utility company to treat polluted waters and sewage-treatment discharges after the carbon emissions and polluted water are mixed in a series of water-conditioners, properly spaced to keep the mixture of the emissions and the waste-water treatment discharges at a designated value for biodynamic water-purification or for breeding of planktons as raw materials to be refined into biofuels. The system engineering renders the environment-engineering undertakings such as CCU, biodynamical water-purification, and manufacturing of biofuels enormously profitable for a public utility company. Another system engineering of water-saving arid irrigation practices of arid irrigation for the greening of desert could capture the excess of atmospheric carbon dioxide.

### BACKGROUND OF THE INVENTION

1. Field of the Invention

The invention is directed to the construction of installations to carry out the processes of producing biologically cleaned waste-water discharges, of harvesting cyanobacteria for biofuel, and of the rehabilitation as lakes and streams as source of water-supply, and of storing, extracting, circulating and transporting groundwater at a rapid rate.

2. Discussion of the Related Art

Urban water-shortage is a problem. In temperate humid climate, the supply is limited where surface waters are badly polluted. In arid regions, the shortage is even more acute. In coastal cities, such as Al Khobar in Saudi Arabia, water supply depends upon desalinized seawater mixed with groundwater. For inland cities, such as New Dunghuang in Northwest China, glacier-melt water from distant mountains has to be brought.

The pollution is caused mainly by the luxuriant growth of algae in streams and lakes contaminated by alkaline nutrient-rich sewage-treatment discharges. A process for suppressing the growth of polluting algae in aqueous systems has been patented in U.S. Pat. No. 7,632,414 B2, 2009, which is hereby incorporated by reference in its entirety for all purposes. Carbon dioxide from carbon emissions produced by industry is mixed with sewage-treatment discharges to change their pH to a range of 5.5-6.5 in a linear bioreactor, so that the biologically cleaned water could be recycled. The mixing could take place in a container, where the pH of the water is monitored to adjust automatically the inflow rate of the carbon emissions, to keep the mixed outflow at a desired pH value. Therein, WO 2008/053174 directed to a method of producing small bubbles of gas in a liquid comprises a source of the gas under pressure, a conduit opening into a liquid and oscillating the gas passing along the conduit at a frequency between 1 and 100 Hz and is relevant thereto.

The air pollution by carbon emissions is biggest problem of the 21st Century. Not only the polluted air is a health hazard, also the increase of carbon dioxide content of the atmosphere and the enhanced greenhouse effect is causing climate change. The melting of Arctic Ice is an undeniable evidence of Global Warming. The consequence, as predicted by the Theory of Glaciation by Ewing and Dunn, is being verified by the recent changes in weather patterns. With the saturation of the polar vortex by the cold and moist arc air, the movement of the high-pressure front has caused the cold and snowy winters in high-northern latitudes. The albedo effect of the snow fields should lead to a reversal of the warming. The ensuing cooling is to accelerate the return of a little ice age, perhaps within 50 years. The catastrophic consequences of the 4 Little Ice Ages during the last 4 millennia have been recorded in the history of Europe and of Asia, as I described in my book Klima machte Geschicht (Orell Fuessli, 2000).

The two approaches to mitigate the problem of air pollution are to stop burning the high carbon fuels, or to capture carbon emissions for storage (CCU) or for utilization (CCU). The searches of alternative energies have not been entirely satisfactory, not to mention that hydrocarbons are not only fuels but also chemicals, and petrochemicals are indispensable for the modern World. The other solutions of CCS and CCU have so far not been successful. CCS processes are economically very costly, and are thus not likely to be useful. Utilization could reduce the cost. Many organizations, especially in PRC, are engaged in CCU research. Carbon emissions from factories are purified and stored above critical temperature in pressurized vessels, to be transported to destinations for utilizations. Unfortunately, few utilizations other than the use of carbon dioxide for sparkling soft drinks have been found.

Researches over the last two decades have led to innovative technologies, which required 1) carbon emissions to rehabilitate polluted environments, 2) to produce biodynamically cleaned sources of water supply for recycling, 3) of breeding and harvesting planktons (diatoms, green algae, & cyanobacteria) for biofuel. Carbon emissions from stationary sources, such as electricity-generating plants, steel mills, cement plants could thus be collected for such utilizations. Furthermore, an innovative system engineering of processes has been developed, called integrated hydrologic circuit (IHC) of storing, extracting, circulating and transporting water underground Those water-saving IHC processes applied to arid irrigation could provide enough water for the greening of desert as a CCU process that catches the carbon dioxide released from moving.

### SUMMARY OF THE INVENTION

A system-engineering installation for water- and energy-recycling in an aqueous system, either in or near a city, and/or in a pre-existing or a new city park, includes
a) one by an utility company to collect carbon emissions wherein the carbon dioxide is produced by burning of high-carbon fuels or lime,
b) one by an utility company to treat waste-water and discharge treated waste-water,
c) a series of water-conditioners, properly space to keep the mixture of the emissions and the waste-water treatment discharges slightly acidic,
d) a small lake or large pond as aerial-bioreactor with a sufficient depth so that the surface layer is alkaline to breed cyanobacteria, with the CO₂ coming up from dissolved carbon emission and the nutrients coming up from sewage-treatment discharges in the main body below the surface layer.
e) a micro-floatation system to harvest the planktons in the water, especially the cyanobacteria, for manufacturing of biofuels,
f) natural stream or artificially dug canal as linear-bioreactor for biologic cleaning of the nutrient-rich sewage-treatment discharges or polluted waters,
g) hydrortransistors for filtration of surface waters, for groundwater recharge, and for circulating groundwater for water-saving circulation to achieve the goal of water- and energy-recycling,
h) a Neo-Canerjing System for underground transport of water to avoid evaporative loss.

The carbon emissions (CCU) that have been purified and captured can be used:
a) for rehabilitation of polluted environments,
b) for harvesting waste-algae from polluted aqueous environment to be ingested for the production of biogas,
c) for breeding algae and cyanobacteria, especially the lipid-rich species, to be refined as biofuel such as biodiesel,
d) for purification of polluted water as sources of water-supply, suitable for prevention and cure of cancer,
e) for recharging biologically cleaned surface waters underground, to be transported as groundwater in aquifers in pressure-induced hydrodynamic field, and to be stored and circulated underground for water-saving irrigation so that evaporative losses could be minimized, and the greening of desert should be an additional carbon-capture utilization process.

### BRIEF DESCRIPTIONS OF DRAWINGS

FIG. 1 is a schematic plan view of a city park for water and energy recycling.

FIG. 2. is a section drawing of a lake for energy recycling.

### DETAILED DESCRIPTION OF THE INVENTION

The teachings U.S. Pat. No. 7,632,414 have been used in a device in the Beijing experiments of the present invention as a “water-conditioner,” which “conditions” the pH of a mixed water.

This biologic cleaning process could also be applied to clean up polluted lakes and streams, where they are polluted by algal growth. The dead remains of the exterminated polluting algae would decay and form a oil-film on the water-surface. The problem was solved when W. Zimmerman of the Sheffield University developed and patented a micro-floatation process to harvest the algae.

### Modification of Sewage-Treatment Works for Water-Recycling

The present invention teaches the recycling of biologically cleaned polluted water or sewage-treatment as source of urban and rural water supplies.

The chemistry of polluted-water samples, of sewage-treatment discharges and of biologically cleaned water samples is shown by Table 1. In preliminary studies, we made random analyses of the samples from a sewage-treatment plant at Beijing, from a polluted stream at Jade Lake Park (JPL) of Beijing, from a sewage-treatment plant at Dongguang, and from another at Anyang (Henan). Almost all samples before biologic cleaning have higher concentration of N & P and of nitrite than the MPCL Standard (Table 1).

In a first example, at Anyang, Henan, discharges commonly have unacceptably higher concentration of phosphorous and nitrogen than the MPCL Standard (Table 1). The plant chose an arbitrary MPCL of 30 mg/l for N, of 25 mg/l for ammonia, 1.0 mg/l for nitrite-N, and 8.8 mg/l P. Those discharges that meet the standard would be worse than Grade V, the most polluted natural water. In fact, the pollutants of the treated discharges at Anyang often exceed those MPCL, with 66 mg/l N, 44 mg/l ammonia, and 1.0 mg/l P.

At a second example, Dongguang, Guangdong, a plant has chosen an arbitrary MPCL of 10 mg/l ammonia, 0.02 mg/l nitrite-N, and 0.5 mg/l P. The treated discharge samples have 17 mg/l ammonia, and 0.059 mg/1 nitrite-N, and 1.8 mg/1 P, exceeding even those rather tolerant MPCL.

TABLE 1
Total N, Ammonia N, Nitrite and Total P concentrations in waters

| | Total N | Ammonia | Nitrite | Total |
|---|---|---|---|---|
| Sample | Actual/Standard | Actual/Standard | Actual/Standard* | Actual/Standard |
| Sewage inflow | 26.55 | 0.6 | — | 0.71 |
| Beijing | | | | |
| Treated, Beijing | 24.98 | 0.4 | 0.011-0.20/0.020 | 0.85/0.3-0.5 |
| Sewage, IHC, | 28.4 | 1.2 | ? | 1.5 |
| Beijing | | | | |
| Sewage, | 24.4 | 1.2 | ? | 0.5 |
| Treated IHC, | | | | |
| Beijing | | | | |
| JLP, inflow | 2.12 | 0.36 | 0.0353 | 19.1 |
| JLP, filtered, | 1.68 | 0.14 | 0.005/0.0200 | 0.57 |
| acid. | | | | |
| JLP, bio- | 1.16 | 0.10 | 0.003/0.0200 | 0.30/0.3-0.5 |
| cleaned 1-week, | | | | |
| winter | | | | |
| JLP, bio-clean 4 | 1.24 | 0.11 | 0.000/0.0200 | 0.346/0.3-0.5 |
| months, winter | | | | |
| JLP, bio- | 1.01 | 0.12 | 0/0004/0.0200 | |
| cleaned 2 | | | | |
| weeks, spring | | | | |
| Sewage, | 20.51 | 13.78/18.66 | 0.072 | 2.54/8.8 |
| Dongguang | | | | |
| Treated, | 18/20 | 17/10 | 0.059/0.020 | 0.2-1.8/0.5 |
| Dongguang | | | | |
| Sewage/Anyang | 33-66/30 | 22-44/50 | | 3.9-10.4/8.8 |
| Inflow | | | | |
| Treated, | 20-45/30 | 1.4-33/25 | | 0.3-1.9/1.0 |
| Anyang | | | | |
| Discharge | | | | |
| I Grade Water | 0.2 | 0.015 | 0.1 | 0.01 |
| II. Grade Water | 0.5 | 0.5 | 0.1 | 0.025 |
| III. Grade | 1.0 | 1.0 | 0.15 | 0.05 |
| Water | | | | |
| IV. Grade | 1.5 | 1.5 | 1.0 | 0.2 |
| Water | | | | |
| V. Grade Water | 2.0 | 2.0 | 1.0 | 0.2 |

Of particular concern to the public health is the nitrite pollution. Currently the MPCL of nitrite in water supply, as specified by the WHO and buy the Chinese Commission of Standard, is 1.0 mg/l nitrite-N. Statistical studies have, however, convinced the Chinese Government that cancer-epidemics in newly developed urban areas are linked to the pollution by the relatively nitrite-rich sewage-treatment discharges. The Chinese Ministry of Health recommends that the public should drink bottled water purified by reverse osmosis, with a nitrite content less than 0.002 mg. Meanwhile, the Chinese Ministry of Environmental Protection consider the link between nitrite and cancer “an established fact,” and the Ministry has lowered the MPCL of source of water for groundwater recharge to 0.01 mg/l nitrite-N. Practically all sewage-treatment discharges cannot meet this standard for groundwater-recharge. They are dumped into the streams or lakes, or used for irrigation, so that shallow groundwater is polluted by nitrite. This has caused the spread of “cancer villages” in epidemic proportions.

Table 2 summarizes the history of discovery at Linzhou County Henan. All people of the County's 17 water districts drank Hongqi Canal Water during the years 1964-74, when the nitrite-rich water from the newly built Hongqi Canal. The new water source caused a cancer epidemic, when the formal cancer-cancer mortality rate was doubled. During the drought years 2001-2003, only the people from 2 water districts drank Hongqi Canal water, where the cancer mortality rate remained high. Elsewhere the source of water supply came from nitrite-free groundwater, and the cancer mortality rate was reduced to less than half,—a rate about the same as that prior to the construction of the Canal. Since then, a statistical correlation between nitrite and cancer-mortality rate has been recognized in many other areas where new sewage-treatment plants are built. The link is now considered an established fact, and the Chinese Prime Minister's Office has appropriated billions of emergency funds to help cancer villages to drill for nitrite-free groundwater.

TABLE 2
Annual Esophageal-Cancer Mortality-Rate (in persons per 100,000) at 14
Townships of Linzhuo Co.

| | 1964-74 | Mortality- | 2001-03 | Mortality- |
|---|---|---|---|---|
| Township, | Main source | rate | Main source | rate |
| Rencun, | Hongqi Canal | 184 | Hongqi Canal | 163 |
| Donggang, | Hongqi Canal | 141 | Hongqi Canal | 145 |
| Shibanyan, | Hongqi Canal | 177 | Mixed | 91 |
| Yaocun, | Hongqi Canal | 171 | Mixed | 118 |
| Lingyang, | Hongqi Canal | 170 | Mixed | 132 |
| Heshun, | Hongqi Canal | 128 | Mixed | 102 |
| Chengguang, | Hongqi Canal. | 110 | Groundwater | 90 |
| Chengjiao | Hongqi Canal | ? | Groundwater | 48 |
| Hongshu, | Hongqi Canal | 113 | Groundwater | 61 |
| Caishang | Hongqi Canal | 76 | Groundwater | 32 |
| Hejian | Hongqi Canal | 81 | Groundwater | 37 |
| Dongyao | Hongqi Canal | 80 | Groundwater | 38 |
| Guilin | Hongqi Canal | 95 | Groundwater | 45 |
| Yuankang | Hongqi Canal | 92 | Groundwater | 77 |
| Cadian | Qi River | 102 | Qi River | 81 |
| Zhexia | Qi River | 89 | Qi River | 81 |
| Linqi | Qi River | 90 | Qi River | 109 |

We are proposing to the Chinese Government that all discharges of sewage-treatment works have to be modified for water recycling. The method taught by this patent is an environmentally friendly and economically most feasible process of de-nitrification.

The linear-bioreactors for biologic cleaning could be streams or canals in the humid climate. We could use the canals into which the sewage-treatment discharges are emptied. The length of the canals depends the inflow rate of the sewage-treatment discharges and the residence time of the diatoms that extract the nutrients. The time needed for the biologic cleaning could be less than a week, or more than a month. To clean biologically the daily treated-discharges of Beijing at 1.5 million tons per day, 250-m wide, 4-m deep streams and/or canals, with a total length of some 20 km long, are needed for the biologic cleaning, assuming that a two-weeks long process.

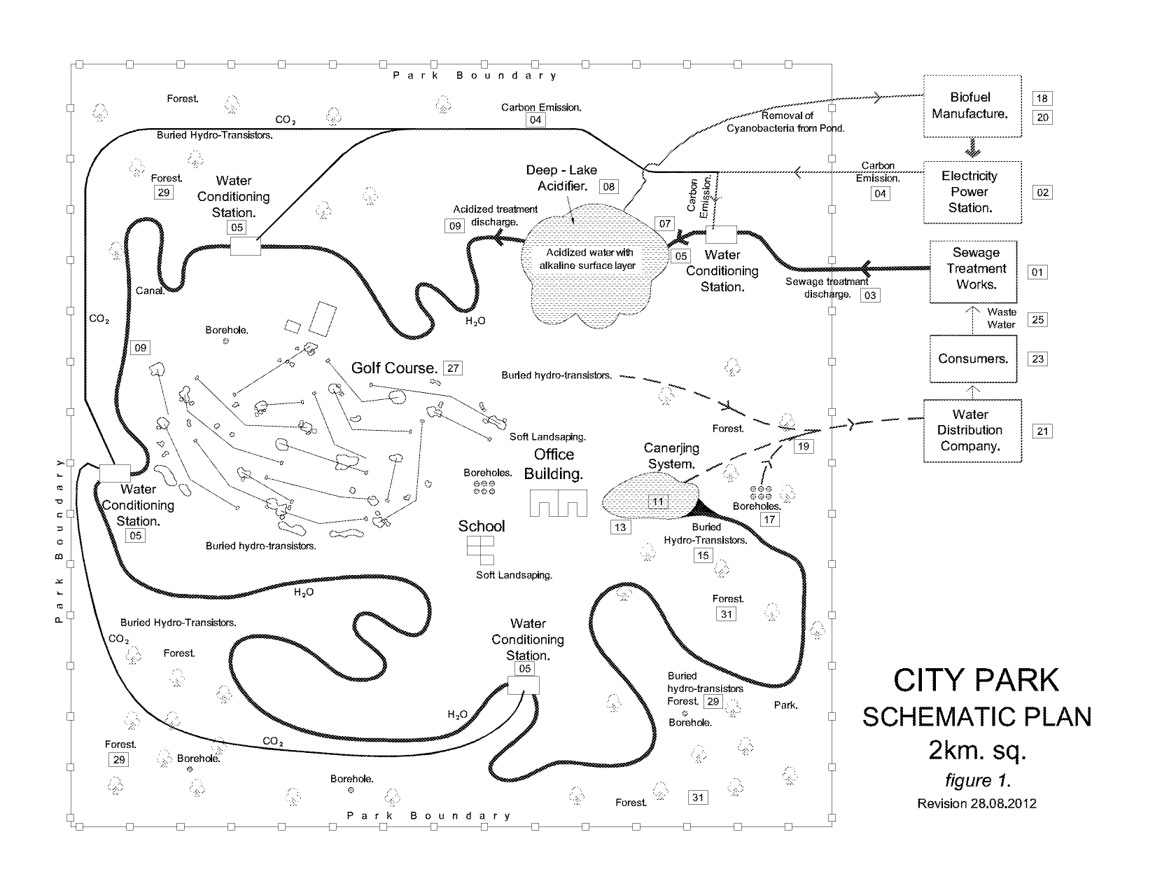

In arid regions, we have to dig canals in city parks for diatoms to grow to perform the task (FIG. 1). The meandering canals should be relatively deep in order to minimize evaporative water loss during the biologic cleaning.

### Culturing Cyanobacteria for Energy-Recycling

This patent teaches the also the culturing of cyanobacteria to utilize carbon emissions to manufacture biofuel, as represented the equation

$$Carbon emissions + Sewage \text{-} Treatment Discharges + Solar Energy ( photosynthesis ) = Clean Air + Clean Water + Food ( aquaculture ) + Energy ( biofuel )$$

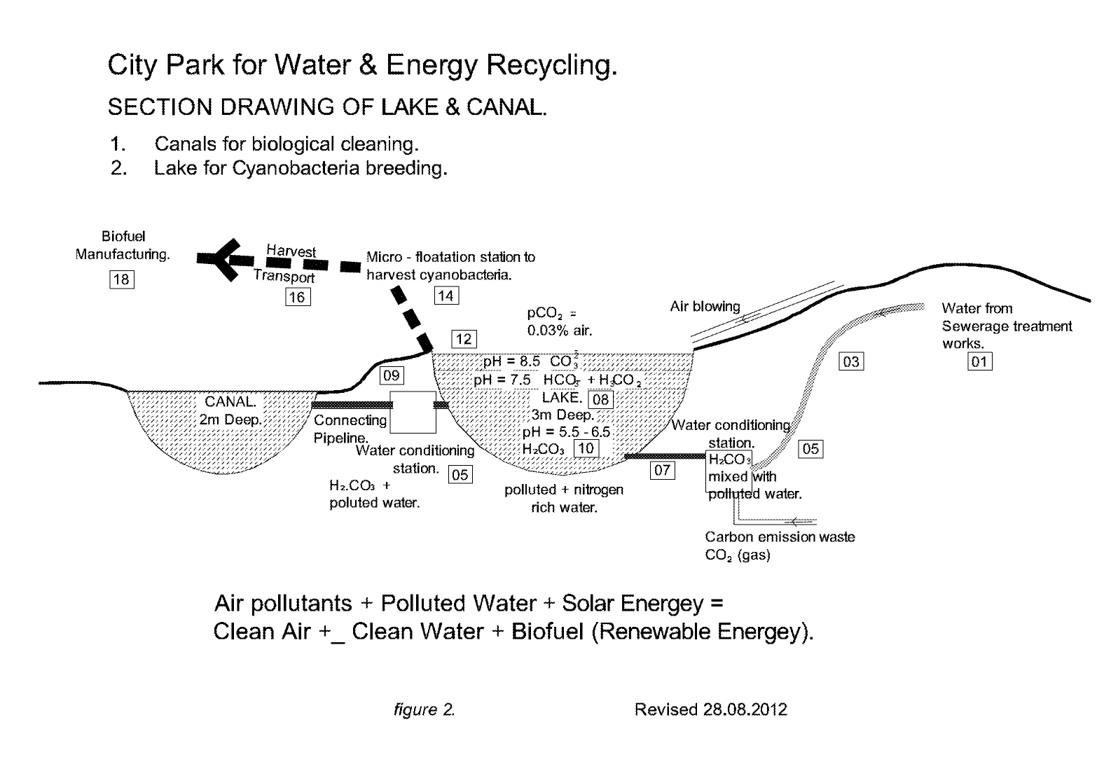

Green algae and cyanobacteria (“blue-green algae”) are most suitable source materials for the manufacturing of biofuel, and their culture could be a very lucrative business. The refining of algal species that contain up to 85% lipid costs only about 500 $/ton, whereas the refined bio-diesel could be sold for some 1,450 $/ton. The population of a metropolitan city will produce enough sewage, and will burn much high-carbon fuel for electricity-generation to produce enough carbon emissions. There will always be enough sunshine for the photosynthesis of cyanobacteria. With the culturing of green algae and cyanobacteria, enough biomethane and biodiesel could be produced for the population of the municipality.

Whereas the main body of polluted water is acidified for biologic cleaning, its surface layer could be kept alkaline for the growth of cyanobacteria. This is possible through the construction of a sufficiently deep water-body with a layered structure (FIG. 2). After the mixing of carbon emission and a nutrient-rich water in a water-conditioner. The dissolved CO₂ becomes carbonic acid:

CO₂+H₂O═H₂.CO₃ (1)

The main body of the water, a pond or a lake, is thus rendered acidic, but the dissolved carbon dioxide near the surface is converted by the equilibration with air into carbonate ions:

H₂.CO₃═2H⁺+CO₃⁻ (2)

Its surface layer is thus saturated with carbonate ions and becomes alkaline, with an equilibrium pH value of about 8.1. Such an alkaline surface environment is thus suitable for the growth of cyanobacteria.

Instead of a meagre supply of CO₂ from the atmosphere, the carbonate ions in the surface-layer are steadily supplied by the microfloatation technology invented by W. Zimmerman, from the depth where the dissolved CO₂ has a high concentration because of its acidity. With the ample supply derived from carbon emissions and of nutrients from the sewage-treatment discharges, cyanobacteria can grow very fast. Our experiments indicated that we could have cyanobacteria harvest every two weeks, instead of annual algal blooms in natural environments once or twice a year.

Every sewage-treatment work has a sedimentation pond to remove the sediment-debris in suspension, and the residence time of the sewage being treated is limited because of the cost-consideration. At many places, the treated water has to go through the sedimentation more than once. With the linear bioreactor such as a canal, there is no need for a sedimentation pond, when the fine debris could settle out of the suspension while a treatment discharge is being biologically cleaned. The existing sedimentation ponds at a sewage-treatment work could thus be modified to be the “areal bioreactor.” Where the source of nutrient-rich water comes from the polluted lakes, a part of the lake could be isolated from the rest through the construction of dykes that separate shallow areas for cyanobacteria-culturing. In either case, acidized nutrient-rich water could enter, at some depth from the surface, the water-body where cyanobacteria is cultured, so that the bioreactor retains a layered structure.

A part of the biologically cleaned water, free of nitrite-pollution, is injected into hydrotransistors buried under green areas for groundwater recharge.

### Hydrotransistors for Water-Supply Works and Greening of Desert

Hydrotransistors are amplifiers. Electronic transistors amplify electric currents. Hydrotransistors amplify water-flows of a porous medium, i.e., they make water entering underground faster for recharge, in and out faster for filtration, and out faster for urban water-supply works. The basic elements are a) a layer of porous medium, gravel or coarse sand, b) perforated pipes buried in the layer into which water is injected or extracted, by c) pumps.

Normally groundwater recharge depends on the seeping from lakes, streams, reservoirs, or down a porous vadose zone. With a 10-15% efficiency of recharging the annual precipitation, excess precipitation could be a nuisance, causing flooding during storms. Excess rainwater flowing into the sewage canals results in extra expenses of sewage-treatment. Installations of hydrotransistors could greatly thus greatly increase the efficiency of the groundwater-recharge. Another use of the hydrotransistor is to recharge the biologically cleaned sewage-treatment discharges underground to be stored as sources of water supply. Such a measure could overcome the reluctance of the public to drink what has once been sewage.

Still another application of hydrotransistors is to recycle groundwater for water-saving irrigation. The installation of perforated pipes in a layer of porous medium serves to accelerate the water-motion in recharge, or in exploiting groundwater for urban waters-supplies.

Hydrotransistors could be buried shallowly, so that water in transit could be drawn up by the capillary pressure of the soil to nurture the growth of plants, such as grass of a lawn or crops in a field. Hydrotransistors are thus useful for urban greening.

An integrated hydrologic circuit has been invented (Taiwan Patent 477852, 2002), and the most important component of the circuit is the hydrotransistor (Taiwan Patent 477852, 2002 & WO 2008/064722/A2, 2008). They could be buried shallowly underground, for groundwater recharge, for water-saving irrigation, and for rapid exploitation of the groundwater.

Our experiments at Abu Dhabi indicated that the ground-evaporation rate is reduced to less than 10% at 1 m. depth, and there is hardly any evaporative loss if the groundwater table in sand is more than a few meters deep. The knowledge should be used to save water-consumption. We should plant trees in city parks on the side of roads, or to make small forest. A very simple water-saving device is to lay a layer of coarse sand or pea gravel above the soil in which trees grow. The sand or gravel has large pore-space and very little capillary force to pull water up from the soil in tree the trees grow. The evaporative loss could thus be reduced to a minimum. Depending upon local conditions of the precipitation and evaporation rates, the thickness of coarse-sediment layer could be adjusted so that the tree in arid regions could depend upon natural rainfall and not require watering.

Water enters quickly into and out of coarse sediment, so that the F-hydrotransistors could be built to function as a filter. When the biologically cleaned canal or stream water is chemically purified, the exposure to natural conditions could not avoid the debris and particles to enter as suspensions. They have to be filtered to be used as the source of water supply. Filtration-hydrotransistors should be built in the area at the end of linear-bioreactors, i.e., the end of a system of meandering canals where polluted waters or sewage-treatment discharges have been biologically cleaned to become source of water supply.

Cities of arid regions should not have surface-reservoirs to avoid the loss to evaporation. The biologically cleaned water should be recharged underground. For cities where a large quantity of water has to be pumped out quickly, wells would be insufficient. We have designed a Kaohsiung Model of WS—hydrotransistors to extract groundwater at a rate sufficiently rapid for consumption by a metropolitan population.

### Neo-Canerjing System

The inhabitants of Northwest China use a Canerjing System to transport groundwater. The system consists of a series of canals. The head of the system is a borehole drilled into the groundwater under the alluvial fans on a mountain front. Water flows in the canals under gravity down to the desert plains where the water is pumped up for irrigation or urban water supply. Having recognized that compressional waves, travelling 1.0 km/s could be generated in water-saturated porous medium, we have been experimenting the changes of hydrodynamic potential in response to wave-propagation. In a perfectly insulated aquifer, water pumped in at one end, will come out almost instantaneously at the other end. In water-flooding for secondary oil-recovery, water injected into one well will sweep out about the same quantity of the oil on its path to be pumped out the production well. Of course, compressional waves are attenuated during energy-transport; one cannot hear people's speech at a short distance away. Similarly our experiments show that a decrease of hydrodynamic potential during transport, so that the forward rate could become negligible, at some distance, where the potential difference becomes nil. Water pumped into an aquifer may seep away so that little water comes out at other end. An aquifer well insulated by impermeable layers above and below would be rapid ground transport laterally.

We are proposing a Neo-Canerjing System to transport water underground. The system consists of a relay of pairs of wells—one for injection and one for extraction of water. We shall tentatively start with a spacing of wells 1 km apart. The distance could be more where we could find well-insulated aquifer in a hydrologic domain.

FIG. 1, City Park for Water and Energy Recycling, is a schematic plan view of a city park for water and energy recycling. The sources of for recycling come from sewage-treatment work (01) discharging treated waste waters (03) and from electricity-generating plant (02) producing carbon emissions by burning high-carbon fuels (04). The two are mixed in a water-conditioner (05) so that the acidified discharge (07) will have a pH value of 5.5-6.5.

The acidified discharge is emptied in a areal-bioreactor,—in this case, a small lake of considerable depth (08). While the discharge remains acidic at the lower part of the lake(10), the surface layer (12) becomes alkaline through equilibration with the air. Cyanobacteria grows in the alkaline water, and is harvested at the micro-floatation station (14). The harvests (16) could then be shipped on land to a biofuel-refinery (18), where the cyanobacteria is refined to yield biofuel (20), to be sold to the electricity-generation plan (02), thus completing thus the energy-recycling process.

The acidified discharge from the lower part of the pond (08) flows down a linear bioreactor, in this case a meandering canal (090. The pH value tends to increase because the equilibration with the atmosphere. The pH is thus monitored and could be kept more or less constant at value of 5.5-6.5 through mixing with carbon emissions (04) from the electricity-generating plant (02) at another water-conditioning station (05), before the newly acidified discharge returns to the meandering canal (09). The canal is designed to have enough length so that the residence time of the acidified discharge in the canal is long enough for the completion of biologic cleaning by diatoms. Finally the acidified discharge is sufficiently cleaned up to be emptied into a shallow lake (11) as the suitable source of drinking water (13), where the pH could gradually becomes neutral or alkaline in equilibration with the atmosphere. The lake water seeps through the lake bottom into a hydrotransistor (15) to be recharged underground through the vadose zone. A part is pumped into boreholes (17) at the head of a pressure-driven canerjing system, to be transported in rapid groundwater motion (19) through an aquifer to a water-supply work (21) to become the water-supply (23) for consumers. The water-cycling is complete, when the waste water (27) returns to the sewage-treatment work (01).

A part of the biologically cleaned water, free of nitrite-pollution is injected into hydrotransistors, which are buried under a golf course (29), or under green areas where trees grow (31). Still another part is injected into boreholes for groundwater recharge. The level of groundwater table under the part is thus raised, where it is transported underground (to avoid evaporation) by pressure-driven canerjing systems to the water-distribution company (21) for public consumption (23), and thus completing another route of water-recycling when waste waters (27) return to the sewage-treatment plant (01).

FIG. 2 is a section drawing of a lake for energy recycling. Treated waste-water (03) and carbon emissions (04) are mixed in a water-conditioning station (05), where the two are mixed are mixed in a water-conditioner (05) to produce an acidified discharge (07) will have a pH value of 5.5-6.5. After flowing into the small lake (08), the discharge still remains slightly acidic in the lower more stationary depth of the pond (10), the surface layer (12) becomes alkaline after equilibration with air. Cyanobacteria grows in the alkaline water, and is harvested at the micro-floatation station (14). The harvests (16) could then be shipped on land to a biofuel-refinery (18), where the cyanobacteria is refined to yield biofuel (20), to be sold to the electricity-generation plan (02), completing thus the energy-recycling process.

While the invention has been described in conjunction with specific embodiments, it is to be understood that many alternatives, modifications, and variations will be apparent to those skilled in the art in light of the foregoing description.

Carbon Dioxide Capture and Reuse

Carbon dioxide can be useful in two different ways. When it is dissolved in water, the mixture becomes slightly acidic, when the dissolved gas becomes the weak carbonic acid. Calcareous algae and cyanobacteria prefer alkaline environments. They are pollutants because they are not feed for aquatic faunas. Diatoms prefer instead slightly acidic environment. They could not only extract the excess nutrients, but they are feed for aquatic faunas so that the nutrients could be mixed in fecal pellets to settle down on water-bottom so that there would not be an excess in water. Carbon emissions could thus be utilized to change the ecologic environment of plankton-growth. Carbon dioxide could also be combined with the hydrogen in planktons to make biofuels. Carbon emissions could thus be changed from a waste gas into a valuable resource to manufacture environmentally friendly, renewable biofuels.

Recaptured carbon can be used in the following ways:
a) to purchase captured carbon emissions from stationary sources wherein the carbon dioxide is produced by burning of high-carbon fuels for electricity-generation, steel-making, cement-manufacturing, etc.
b) to collect waste waters from polluted environments, and/or waste-water treatment discharges.
c) to feed captured carbon-emissions to algae-infested waters and to apply a micro-floatation technique, developed by W. Zimmerman, to harvest the polluting algae to be processed for the generation of biogas methane.
d) to mix a fraction of the nutrient-rich water from polluted environment with carbon emissions in water-conditioners, developed by me, to keep the mixture alkaline, which is to flow into a series of ponds to breed lipid rich-plankton, as raw materials for biofuels.
e) to channelize the main body of polluted water, now deprived of its polluting algae, to be mixed with captured carbon emissions in water-conditioners, where the mixture is kept slight acidic to produce an ecologic environment suitable for the growth of diatoms.
f) to eliminate the algal pollution, when the excess nutrients in water are extrated by the growing diatoms.

1. The invention of a profit-making system-engineering, linking up various innovative technologies to construct installations to recycle carbon emissions and polluted water, through carbon-capture utilization, to give us clean air, clean water, and inexhaustible supply of renewable biofuels, represented by the equation: Carbon emissions+Polluted Water+Solar Energy+Patented=Clean Air+Clean Water+Food supply+Profit, the system engineering comprising:
a) one by a CCU company to collect carbon emissions from stationary sources wherein the carbon dioxide is produced by burning of high-carbon fuels or lime,
b) one to use captured carbon emission to be mixed with polluted water in a micro-floatation system to harvest its green and blue-green algae for manufacturing of biogas,
c) one to use captured carbon emission to be mixed with nutrient-rich water in a series of ponds to breed lipid-rich algae for manufacturing of biodiesel.
d) one to mix captured carbon emission with polluted water in a series of water-conditioners where the mixture is kept slightly acidic for the culturing of diatoms to eliminate pollution,
e) one for filtration of polluted water or waste-water discharge that has been treated as source of water supply, source of groundwater recharge, to be transported and stored underground for water-saving irrigation and the greening of desert.

2. The use of the system-engineering system according claim 1 so that the carbon emissions could be profitably captured and utilized to alleviate the threat of Global Warming and Climate Change.

3. The use of the system-engineering system according claim 1 so that carbon emissions could be profitably captured for rehabilitation of polluted aqueous environment.

4. The use of the system-engineering system according claim 1 so that carbon emissions could be profitably captured for the recycling of waste-water as sources of water supplies.

5. The use of the system-engineering system according claim 1 so that carbon emissions could be profitably captured for the manufacturing of renewable biofuels.

6. The use of the system-engineering system according claim 1 when carbon emissions could be profitably captured so that there could be no objection to the burning of high carbon fuels, coal, petroleum, and biofuels.

7. A system-engineering, combining a new technology of water-transport (Neo-canerjing system) and the previously patented technology of water-saving irrigation (IHC system) to grow plants in deserts for the capturing of atmospheric carbon dioxide to alleviate Global Warming and Climate changes.
